(19) United States
(12) Patent Application Publication
(10) Pub. No.: US 2005/0112346 A1
(43) Pub. Date: May 26, 2005

(54) Method for the production of PET sheets

(76) Inventor: Werner Ehrhardt, Hammersbach (DE)

Correspondence Address: Raafat M. Shaltout;McDonnell Boehnen Hulbert & Berghoff LLP, 31st Floor, 300 S. Wacker Drive, Chicago, IL, 60606, US

(21) Appl. No.: 10/993,339

(22) Filed: Nov. 19, 2004

(30) Foreign Application Priority Data
Nov. 21, 2003 (DE) 103 54 732 .0

(51) Int. Cl. B29C 39/14; B29C 55/06; B29C 55/08

(52) U.S. Cl. 428/220; 264/216; 264/288.4; 264/290.2

(57) ABSTRACT

The present invention relates to a method for the production of PET sheets, in which a polyethylene cerephthalare melt is transferred onto a roller and the obtained film is stretched longitudinally, whereby, for the preparation of the polyethylene rerephthalate present in the melt, a branching agent is used in a concentration from 50 to 300 ppm, related to the total weight of the polyethylene terephthalace contained in the melt.

The present invention relates to a method for the production of PET sheets as well as sheets thereby obtained.

Polyethylene terephthalate is a generally known plastic which is used in a variety of ways. In order to improve various properties, branching agents. amongst other things. are used for the production of these plastics. It concerns tri- or tetra-functional carboxylic acids, alcohols or their derivatives, such as for example trimellitic acid or trimethylol propane In the past, they have been used preferentially for fibre and bottle polyesters, in order for example to achieve higher melt strengths, higher strengths and improved tinting behaviour

Publication DE 1720235 describes the production of copolyester fibres with raised strength, Pilling resistance and tintability, whereby the improvements are due in particular to the joint use of bisphenol-A-diglycol ethers and penzaerythrite. Pentaerythrite is used in quantities of 52-151 ppm.

In U.S. Pat. No. 4,113,704, various branching agents are used for PET fibres, with which branching agents considerable improvements are achieved in respect of strength and take-up speed. Quantities of 66-660 ppm are stated for pentaerythrite.

Publication DE 19841375 discloses the production of a readily tintable copolyester fibre. A combination of carboxyalkyl phosphonic acids, polyalkylene glycols and pentaerythrite is proposed there in order to improve the processing properties and the tintability.

For the production of drink bottles by stretch-blow moulding or extrusion blow moulding, a suitable modified copolyethylene terephthalate is proposed in DE 4125167, in which, besides the comonomers isophthalic acid and diethylene glycol, tri- or tetra-hydroxyalkane units are used for the improvement of the melt strength. The quantities amount to 300-2500 ppm. pentaerythrite being mentioned in the examples.

Publication WO 93/23449 discloses an acceleration of the solid phase polycondensation step in bottle production by the fact that, amongst other things, 50-570 ppm of pentaerythrite is added.

Furthermore, sheets produced using polyethylene terephthalace have also long been known and are used in large quantities. Thus, publication U.S. Pat. No. 2,823,421, for example, describes a method for the production of PET sheets. A summary outline is presented in the Encyclopaedia of Polymer Science and Engineering, vol. 12, 2nd ed., pp 195-210.

DE 1944239 contains the production of virtually colourless photo films and cinema films by means of a zinc catalyst and the addition of at least tri-functional compounds. 1920 ppm is stated for the use of pentaerythrite.

DE 2132074 proposes the improvement of a costly method for the production of PET sheets, which provides for the addition of pentaerythrite to a solid PET precondensate product, which is further polycondensed in an extruder in order to obtain films with the desired properties. The quantities of pentaerythrite regarded as necessary are very high at 4500-10000 ppm. Drawbacks with this method are the high outlay and the associated costs.

W. J. Hennessy and A. L. Spatorico investigated the influence of 5 and 15 ppm of pentaerythrite on the behaviour of PET filing (Polymer Engineering and Science, 19/6, 462-467 (1979)) According to this, an addition of pentaerythrite in this order of magnitude is virtually of no account.

The methods of production described above are in some cases carried out on a large scale commercially. In order to keep the production costs as low as possible, therefore, there is a constant need to increase the production rate of these sheets.

In view of the prior art, the problem of the present invention was co make available a method for the production of PET sheers, with which sheets can be produced at a particularly high speed.

Furthermore, it is also a problem of the present invention to provide methods that can be carried out particularly cost effectively and efficiently. In this regard, the method should be able to be implemented using commercially available installations known per se.

Moreover, the problem consisted in providing a method capable of being implemented on a large scale. Thus, the failure rate, in particular, should be particularly low measured against the high production rate.

Furthermore, the method should be able to be adapted easily to diverse requirements. The sheets obtainable by the method should therefore be able to be adapted to existing requirements without great outlay. In particular, the sheets should exhibit mechanical, optical and electrical properties essentially similar to or better than sheets that have been obtained with known methods.

These and other problems, which are not stated explicitly, but which are readily deducible or derivable from the interrelationships discussed here by way of introduction, are solved by a method for the production of PET sheets with all the features of claim 1. Expedient modifications of the method according to the invention are protected in the sub-claims relating back to claim 1.

Claim 8 provides a solution to the underlying problem in respect of a PET sheet.

Due to the fact that, for the preparation of the polyethylene terephthalate present in the melt, a branching agent is used in a concentration of 50 to 300 ppm, related to the total weight of the polyethylene cerephthalate contained in the melt, it becomes possible, in a manner nor readily foreseeable, to make available methods for the production of PET sheets, in which a polyethylene terephthalate melt is transferred onto a roller and the film obtained is stretched longitudinally, said methods being able to be carried out at high speed.

The method according to the invention at the same time has a number of other advantages. These include, amongst others:

The method according co the invention can be carried out in a simple fashion, on an industrial scale and cost effectively.

The method of the present invention can be carried out using commercially available installations known per se.

Moreover, the method according to the invention can be carried out on a large scale, whereby the failure rate, measured against the high production rate, is particularly small.

Furthermore, the method according to the invention can easily be adapted to diverse requirements. The sheets obtained by means of the method can thus be adapted to existing requirements without any great outlay. In particular, the sheets exhibit mechanical, optical and electrical properties essentially similar to or better than sheets that have been obtained with known methods.

According to the invention, a melt containing polyethylene terephthalate (PET) is processed in the present method. The polyethylene terephthalate can be both a homopolymer as well as a copolymer. As copolymers, consideration can be given in particular to those which, apart from the repeating units of the PET, also contain up to 15 mol. %, related to all the repeating units of the PET, of repeating units of standard comonomers, such as for example 1,3-propanediol, 1,4-butanediol, diethylene glycol, triethylene glycol, 1,4-cyclohexane dimechanol, polyethylene glycol, isophthalic acid and/or adipic acid. PET homopolymers are however preferred within the scope of the present invention.

Furthermore, the polyethylene terephthalate includes 50 to 300 ppm, preferably 60 to 250 ppm, related to the total weight of the polyethylene terephthalate contained in the melt, of at least one branching agent. The branching agents preferred according to the invention include, amongst others, acids or their derivatives with at least three functional groups, such as trimellitic acid, pyromellitic acid or carboxyalkyl phosphonic acids such as carboxyethane phosphonic acid or tri- Co hexa-valent alcohols, such as trimethylol propane, pentaerythrite, dipentaerythrite, glycerine, or corresponding hydroxy acids. The particularly preferred branching agent is pentaerythrite.

The polyethylene terephthalate contained in the melt can generally have an intrinsic viscosity in the range from 0.5-0.7, preferably 0.56-0.65 dL/g, measured in phenol/dichlorobenzene (6:4) at 25° C. (125 mg of PET on 25 ml of solution).

The polyethylene terephthalate according to the invention can contain standard quantities, preferably 0 to 5 wt. %, preferably 0 to 1 wt. %, related in each case to the total weight of the melt, of further additives as admixtures, such as catalysts, stabilisers, antistatic agents, antioxidants, flame retardants, dyestuffs, dye uptake modifiers, light stabilisers, organic phosphates, optical brighteners and dulling agents.

The polyethylene terephthalate melt preferably contains at least 70 wt. %, particularly preferably at least 85 wt. % and very particularly preferably at least 95 wt. %, related to the total weight of the melt, of polyethylene terephthalate.

The melt viscosity at 280° C. can preferably lie in the range from 100 to 600 Pa*s, particularly preferably 200 to 400 Pa*s.

The preparation of the melt containing polyethylene terephthalate can take place by any known method- The melt is preferably produced directly before further processing from the components by polycondensation reactions. The preparation of the polyester takes place continuously or discontinuously in a manner known per se by the reaction of a diol with a diester, such as for example a dimethyl terephthalate or terephthalic acid. Terephthalic acid is preferably used. The dicarboxylic acid diester first arises, which is polycondensed in a single- or multi-stage manner with increasing temperatures whilst reducing the pressure, whereby diol and water are liberated.

Catalysts are generally used for this reaction, such as for example compounds of Ti, Mn, Mg, Ca, Li, Co and/or Zn for transesterification; for example compounds of Sb, Ti, Ge and/or Sn for esterificarion and for example compounds of Sb, Ti, Pb, Ge, Zn and/or Sn or zeolites for polycondensation. The catalysts are used in standard quantities. for example up to 500 ppm, related to the polyester.

The cross-linking agent can be added at the start of the polycondensation reaction. Furthermore, the cross-linking agent can also be added to the reaction mixture at a later time. According to a preferred development of the present invention the cross-linking agent is not added until 80 to 98%, particularly preferably 92 to 98%, of the esterification mixture has esterified. This degree of esterification (U) can be calculated from the saponification number (V_{z}) and the acid number (S_{z}) of the reaction mixture according to U=(V_{z}−S_{z})*100/V_{z} The saponification number is determined by saponification with potassium hydroxide in n-propanol/ethylene glycol (8:2) and potentiometric titration and the acid number is determined by potentiometric titration in dimethyl formamide.

Further details concerning the preparation of the melt containing polyethylene terephthalate are set out in amongst others, the Encyclopaedia of Polymer Science and Engineering, Vol. 12, 2^{nd} Ed, pp 195-210, EP 0 921 145. U.S. Pat. No. 4,113,704 and DE-OS 198 41 375.

The production of PET sheets from the melt containing polyethylene terephthalate is also known, whereby reference is made in this connection to, amongst others, the publications Encyclopaedia of Polymer Science and Engineering, Vol. 12, 2^{nd} Ed, pp 195-210 and U.S. Pat. No. 2,823,421.

The melt containing polyethylene terephthalate can usually be extruded at a temperature in the range from 270 to 310° C. through a nozzle onto a roller, which can generally have a temperature in the range from 60° C. to 80° C. In many cases, a film of amorphous polyethylene thus arises.

The degree of crystallinity of the film directly after leaving the first roller, i.e. before the stretching of the sheet, is generally less than 5%, preferably less than or equal to 1% and in particular less than or equal to 0.5%.

The thickness of the film, which is obtained by transferring the melt containing polyethylene terephthalate onto a roller, can lie in a wide range, whereby this value is dependent on the intended use of the PET sheet as well as the stretching factors in the longitudinal and transverse direction. The thickness of the film generally lies in the range from 3 to 500 μm, preferably 6 to 300 μm.

The speed of the roller onto which the melt containing polyethylene terephthalate is transferred can usually lie in the range from 80 to 140 m/min., preferably 90 to 120 m/min.

The obtained film is then stretched according to the invention in the longitudinal direction, i.e. in the machine running-direction. The film is generally stretched longitudinally at a temperature of 75 to 100° C., preferably 85 to 90° C.

The factor by which the film is stretched preferably lies in the range from 2 to 6, particularly preferably 3 to 5, depending on a single-stretching or multiple-stretching operation.

The film, which has been obtained by transferring the melt containing polyethylene terephthalate onto a roller, is preferably stretched longitudinally at a rate in the range from 200 to 600 m/min., particularly preferably 270 m/min. to 400 m/min.

After this step, the sheet preferably exhibits a degree of crystallinity in the range from 10 to 25%, in particular 15 to 20%.

The sheets thus obtained can be used for example to produce bands for packages.

Furthermore, the PET sheet obtained after the longitudinal stretching can be stretched transversely in a further step, i.e. at right angles co the machine running-direction.

The factor by which the PET sheet is stretched transversely preferably lies in the range from 2 to 5, particularly preferably 3 to 4. The film is generally stretched transversely at a temperature from 90 to 120° C., preferably 100 to 120° C.

After the stretching in the transverse direction, the PET sheet preferably exhibits a crystallinity in the range from 20 to 45%, in particular 30 to 40%.

The PET sheer thus obtained can be used, amongst other things, as packaging material, in particular as shrink film.

Furthermore, the sheet can also undergo a heat stabilisation step, so that the sheet exhibits only a low shrinkage when heated to temperatures of 150° C. or 190° C. For this purpose, the PET sheet stretched transversely is heated for several seconds at temperatures in the range from 180° C. to 220° C. The crystallinity thus increases co approx 50%.

The PET sheets obtained by the method of the present invention can be used in all fields in which conventional PET sheets are also used. The sheets can thus be used to produce films for packaging, for example in the foodstuffs sector and in the medical sector, and films for photography and for data protection, for example microfilms, magnetic capes, sheets for printing applications, for example hot-stamping sheers. The thickness of the PET sheets obtained by the present method generally lies in the range from 1 μm to 350 μm, whereby this value is dependent on the application. The thickness of PET sheets for the production of packaging thus amounts for example to 6 to 250 μm, for films to 50 to 175 μm, for technical films and microfilms to 100 to 200 μm, for the insulation of engines and generators to 250 to 350 μm, whilst the thickness of PET sheets for the production of condensers lies in the range from 1 to 5 μm.

1. A method for the production of PET sheets, in which a polyethylene terephthalate melt is transferred onto a roller and the obtained film is stretched longitudinally, comprising, for the preparation of the polyethylene terephthalate present in the melt, using a branching agent is used in a concentration of 50 to 300 ppm, related to the total weight of the polyethylene terephthalate contained in the melt.

2. The method according to claim 1, wherein the branching agent is a carboxylic acid, a carboxylic acid derivative or an alcohol with at least 3 functional groups.

3. The method according to claim 2, wherein the alcohol is pentaerythrite.

4. The method according to claim 1, wherein the film, which has been obtained by transferring the polyethylene terephthalate melt onto a roller, has a thickness in the range from 3 to 500 μm.

5. The method according to claim 1, wherein the roller onto which the polyethylene terephthalate melt is transferred has a speed in the range from 80 to 140 m/min.

6. The method according to claim 1, wherein the film that has been obtained by transferring the polyethylene terephthalate melt onto a roller is stretched longitudinally at a rate in the range from 200 to 600 m/min.

7. The method according to claim 1, wherein the film that has been obtained by transferring the polyethylene terephthalate melt onto a roller is stretched transversely.

8. A film obtained according to the method of claim 1.

9. The film according to claim 8, wherein the film has a thickness in the range from 1 to 350 μm.

10. The method according to claim 1, wherein the roller onto which the polyethylene terephthalate melt is transferred has a speed in the range from 90 to 120 m/min.

11. The method according to claim 1, wherein the film that has been obtained by transferring the polyethylene terephthalate melt onto a roller is stretched longitudinally at a rate in the range from 270 to 400 m/min.
